(19) United States
(12) Patent Application Publication
(10) Pub. No.: US 2020/0391554 A1
(43) Pub. Date: Dec. 17, 2020

(54) HYBRID CORD REINFORCEMENT FOR A TIRE AND A TIRE COMPRISING A HYBRID CORD REINFORCEMENT

(71) Applicant: THE GOODYEAR TIRE & RUBBER COMPANY, AKRON, OH (US)

(72) Inventor: Romain Jack Rodolphe Mersch, Mersch (LU)

(21) Appl. No.: 16/899,839

(22) Filed: Jun. 12, 2020

Related U.S. Application Data
(60) Provisional application No. 62/862,185, filed on Jun. 17, 2019.

(51) Int. Cl. B60C 9/00

(52) U.S. Cl. CPC B60C 9/005; B60C 2009/0092; B60C 9/0042

(57) ABSTRACT

This invention relates to a hybrid cord for a tire ply or ply strip, wherein the cord comprises two aramid yarns having densities from 1400 to 1900 dtex twisted in a first direction with 5 to 11 twists per inch, a polyamide yarn having a density of 700 to 1200 dtex twisted in the first direction with 4 to 10 twists per inch, wherein the three yarns are twisted together to form the cord, and wherein the cord is twisted with 4 to 10 twists in a direction opposite to the first direction. Moreover, the present invention is directed to a pneumatic tire comprising at least one of a belt ply, a carcass ply, an overlay ply and an overlay ply strip, wherein the ply or ply strip of the tire comprises a plurality of the aforementioned cords.

This application claims benefit of U.S. Provisional Patent Application Ser. No. 62/862,185, filed on Jun. 17, 2019. The teachings of U.S. Provisional Patent Application Ser. No. 62/862,185 are incorporated herein by reference in their entirety.

### FIELD OF THE INVENTION

The present invention is directed to a cord, in particular a hybrid cord for a tire ply or ply strip, in particular for an overlay structure. Moreover, the present invention is directed to a tire comprising such a cord or component.

### BACKGROUND

While tire performance has significantly improved over the past decades, the demands of the users increased as well, especially in the field of race tires. In particular, increasing requirements in the Ultra Ultra High Performance (UUHP) segment are showing the limits of current overlay reinforcing materials which cover ply belts of the tire. Increasing demands are for instance found in high speed performance, durability and handling. Preferable cords which may help to achieve acceptable properties, in particular in overlay plies or ply strips are described in U.S. Pat. No. 6,799,618 which disclose a pneumatic tire having an overlay strip comprising hybrid cords consisting of two aramid yarns and a Nylon yarn twisted together to form a cord. The twist direction of the cord is opposite to the twist directions of the single yarns. While such solutions have helped to increase performance of race tires in the past, significant room for improvement remains.

### SUMMARY OF THE INVENTION

A first object of the invention may be to provide a cord for use in a reinforced tire ply or strip which supports improvements in one or more of the following properties: high speed, ride and handling or durability of the tire.

Another object of the invention may be to provide an improved tire overlay textile reinforcement.

Another object of the invention may be to provide an improved textile reinforced tire, in particular for race or passenger car tires.

In one aspect of the invention, a hybrid (textile) cord for a tire ply or ply strip is provided, the cord comprising two aramid yarns and a polyamide yarn. Each aramid yarn has a density from 1400 to 1900 dtex and is twisted in a first direction with 5 to 11 twists per inch (tpi). The polyamide yarn has a density of 750 to 1200 dtex twisted in the first direction with 4 to 10 twists per inch, wherein the three yarns are twisted together to form the cord, and wherein the cord is twisted with 4 to 10 twists per inch in a direction opposite to the first direction.

It has been found by the inventors that such a construction offers a high modulus, strength and elongation of the cord. In particular, such a construction has been found to be advantageous over constructions having a central core yarn (e.g. Nylon) and a wrap or wraps of aramid yarn. In the invention, all yarns are twisted in the same direction (e.g. Z or S) and then cabled in the opposite direction (e.g. S, or Z respectively). Also, initial modulus is high as the aramid and polyamide yarns are twisted together. Moreover, the claimed combination of the twist multipliers of the aramid and nylon yarns has been found to be advantageous.

Moreover, the construction has shown improved consistency in tensile measurement as such a construction is compact and stable over the different processing steps.

Preferably, the cord comprises exactly said three yarns.

In an embodiment, the two aramid yarns have each a density of 1500 to 1800 dtex, or optionally from 1600 to 1700 dtex, in order to improve the total cord modulus. The polyamide yarn may also have a density of 800 to 1100 dtex, and optionally of 900 to 1000 dtex, for instance, in order to allow additional elongation before breaking the cord during stretching, and/or while allowing a small cord diameter which may reduce the total rubber thickness required to fully cover the cord. Such a range has turned out to be of particular advantage by the inventors.

In addition, or alternatively, the number of twists per inch of each aramid yarn is larger than the number of twists per inch of the polyamide yarn, wherein optionally the number of twists per inch of the polyamide yarn and the cord is essentially the same or deviates less than 10% from one another.

In another embodiment, the number of twists per inch of the aramid yarn has at least 10% twists per inch more than the polyamide yarn and/or has between 10% to 25% twists per inch more than the polyamide yarn. This feature has turned out to be of particular interest for the performance. In particular, the aramid twist level compared to the polyamide allows to further increase the elongation at break of the cord (which is increasing the impact resistance) and its fatigue resistance (which is also beneficial for long term durability of the tire).

In another embodiment, the number of twists per inch of the polyamide yarn and the number of twists per inch of the cord do not differ from each other in more than 0.5 twists per inch, for instance in order to improve the cord stability and compactness.

In still another embodiment, the aramid yarns are (each) twisted with 7 to 9 twists per inch and/or the polyamide yarn is twisted with 6 to 8 twists per inch. The cord may be twisted with 6 to 8 twists per inch.

In yet another embodiment, the polyamide is nylon-6,6, nylon-4,6. nylon-6,9, nylon-6,10, nylon 6.12, nylon-6, nylon-11 or nylon12. In another embodiment, the cord has a construction of 1670/2 dtex aramid+940/1 dtex Nylon, twisted 8Z/7Z/7S twists per inch (tpi). In other words, 2 yarns or strands of aramid having each a weight of 1670 dtex are each twisted with 8 tpi in Z direction. A 940 dtex Nylon is twisted with 7 tpi also in Z direction. Finally, the three yarns are twisted with 7 tpi in the opposite S direction to form the cord out of the three yarns. This configuration has turned out to provide most promising properties in terms of high speed durability/stiffness. Radial tire growth under high speed conditions (e.g. >240 km/h), in particular for large rim diameter tires over 18 inch, is much lower with the new cord, which helps to reduce the deformations and heat generation in the tire crown area. The increased stiffness of the cord is also providing improvements in tire cornering and reactivity.

In another aspect of the invention, a tire is provided which comprises one or more of said hybrid cords.

The pneumatic tire may comprise at least one or more of a belt ply, a carcass ply, an overlay ply and an overlay ply strip, wherein the ply or ply strip of the tire comprises a plurality of cords comprising three yarns twisted together, consisting of two aramid yarns having each a density from 1400 to 1900 dtex being each twisted in a first direction with 5 to 11 twists per inch, a polyamide yarn having a density of 750 to 1200 dtex twisted in the first direction with 4 to 10 twists per inch, and wherein the three yarns form a cord twisted with 4 to 10 twists per inch in the direction opposite to the first direction. The tire has the advantages already stated above in relation to the benefits of the cords.

It is emphasized that not all of the stated tire components (i.e. plies or ply strips) need to comprise the cords in accordance with the invention. It is possible that only one of said components comprises cords of the present invention. Moreover, in accordance with this invention the ply or ply strip does not necessarily comprise merely cords and may also comprise cords according to the invention and other cords. However, in an embodiment all cords or at least 40% or 50% of the cords in a ply or ply strip are cords in accordance with the invention.

In another embodiment, the pneumatic tire comprises a carcass with at least one carcass ply, a tread disposed radially outward of a crown region of the carcass, a belt with a plurality of belt plies arranged between the carcass ply and the tread, wherein the plurality of belt plies is covered by an overlay (structure) comprising a helically wound elastomeric strip, reinforced by a plurality of the cords and extending (transversely) over the belt plies at an angle of between 0° and 5° (optionally between 0° and 2°) with the equatorial plane (EP) of the tire.

In still another embodiment, said strip has a width (w) in the range of from 3 mm to 15 mm and/or a thickness (t) in the range of from 0.8 mm to 3 mm (preferably 2 mm) and/or a fabric density of between 15 to 30 ends per inch (epi). In another embodiment the overlay ply strip has one or more of: a width (w) in the range of 4 mm to 18 mm, a thickness (t) in the range of 0.7 mm to 1.7 mm and a fabric density of from 10 to 40 ends per inch.

In still another embodiment, the tire is a radial race tire or a radial passenger car tire.

### BRIEF DESCRIPTION OF THE DRAWINGS

The structure, operation and advantages of the invention will become more apparent upon contemplation of the following description taken in conjunction with the accompanying drawings, wherein:

FIG. 1 represents a schematic perspective cross-section of a tire in accordance with an embodiment of the invention.

FIG. 2 represents a schematic cross-section of a ply strip, e.g. an overlay ply strip, comprising schematically displayed hybrid cords in accordance with the invention; and

FIG. 3 represents a schematic cross section of a hybrid cord for a tire ply or ply strip in accordance with an embodiment of the invention.

### DETAILED DESCRIPTION OF THE INVENTION

The cords of this invention include two aramid yarns and one polyamide yarn. The aramid yarns are comprised of long-chain aromatic polyamides in which typically at least 85% of the amide linkages (—CO—NH—) therein are attached directly to two aromatic rings. Poly(p-phenyleneterephtalamide) is a representative example of such a aramid that can be utilized in accordance with this invention. Aramid which is suitable for use in the practice of this invention is commercially available from DuPont under the tradename Nomex®, Kevlar® 29, Kevlar® 49, Kevlar® 119, Kevlar® 129, and Kevlar® 149. Aramid which is suitable for use in the practice of this invention is commercially available from Teijin under the tradename Twaron®.

The polyamide (non-aromatic) that is used in the practice of this invention can be prepared by reacting a dibasic acid with a diamine, such as nylon-6,6 (synthesized by reacting hexamethylene diamine with adipic acid), nylon-6,9 (synthesized by reacting hexamethylene diamine with azelaic acid), nylon-6,10 (synthesized by reacting hexamethylene diamine with sebacic acid), nylon-6,12 (synthesized by reacting hexamethylene diamine with dodecanedioic acid), or nylon-4,6 (synthesized by reacting 1,4-diaminobutane with adipic acid). In the alternative, the polyamide that is used in the practice of this invention can be prepared by the polymerization of an amino acid or an amine acid derivative, such as nylon-6 (made by the polymerization of ε-caprolactam), nylon-11 (made by the polymerization of undecanoic acid), or nylon-12 (made by the polymerization of laurolactam).

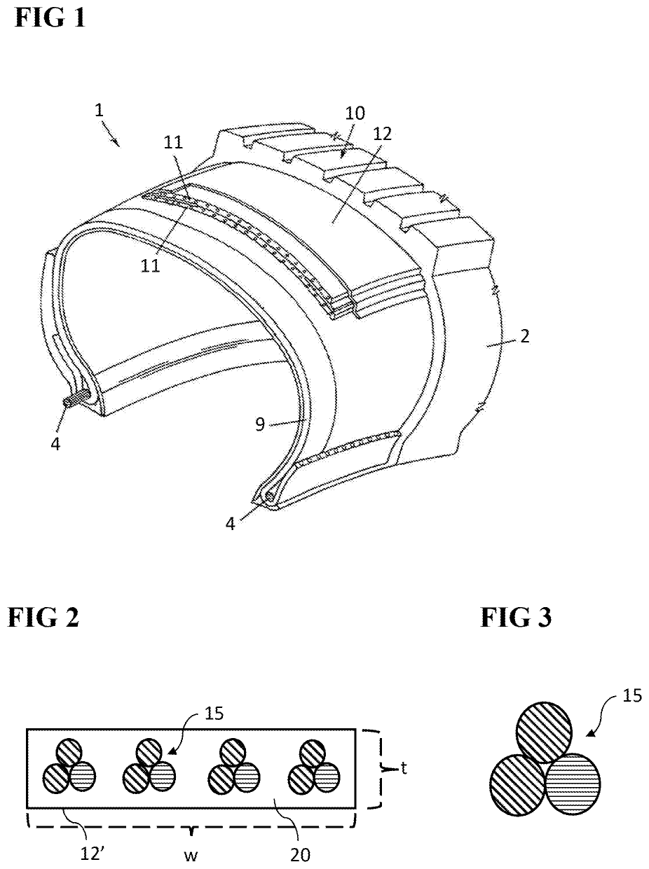

FIG. 1 is a schematic perspective cross-section of a tire 1. The tire 1 has a tread 10, a belt structure comprising two belt plies 11, a carcass ply 9, two sidewalls 2, and two bead regions comprising beads 4. The example tire 1 is suitable, for example, for mounting on a rim of a vehicle, e.g. a race or a passenger car. As shown in FIG. 1, the belt plies 11 may be covered by an overlay ply 12. The overlay ply 12 is shown here as a single ply covering the belt plies 11 of the tire 1. However, the overlay ply 12 or overlay (ply) structure may also consist of a helically wound ply strip such as strip 12′ schematically shown in FIG. 2, or multiple of such strips. In other words, the ply strip 12′ may be wound essentially in a circumferential direction, for instance with an angle of between 0 and 5 degree with the equatorial plane of the tire, covering the radially outermost belt ply 11 radially below the tread 10. The carcass ply 9 of FIG. 1 includes a pair of axially opposite end portions, each of which is associated with a respective one of the beads 4. Each axial end portion of the carcass ply 9 may be turned up and around the respective bead 4 to a position to anchor each axial end portion 6. One or more of the carcass ply 9, belt plies 11 and overlay ply 12 or ply strip(s) 12′ comprise a rubber composition (such compositions are known in the art and are not in the focus of the present invention) and have a plurality of substantially parallel reinforcing members, or in other words textile cords, in accordance with an example of the invention. As shown in FIG. 1, the example tread 10 may have five circumferential grooves, each groove essentially defining a U-shaped opening in the tread 10. The main portion of the tread 10 may be formed of one or more tread compounds, which may be any suitable tread compound or compounds.

While the embodiment of FIG. 1 suggests a plurality of tire components, not all of such components are mandatory for the invention. Also, the turned-up end of the carcass ply 9 is not necessary for the invention or may pass on the opposite side of the bead area 3 and terminate on the axially inner side of the bead 4 instead of the axially outer side of the bead 4. The tire could also have, for instance, more or less than four grooves or even no grooves, as for example in some slick tires. Moreover, the number of belts could be for instance 1, 2, 3, 4 or 5 or even more belt plies 11. Race tires may for example have from 1 to 4 belt plies 11.

The schematic cross-section of FIG. 2 shows a ply strip 12′, e.g. an overlay ply strip 12′ which comprises a plurality of hybrid cords 15 reinforcing the rubber composition material 20. Typically, such a ply strip may be made in a fabric calender or extrusion unit in which a plurality of essentially parallel textile cords (or in other words warp cords) are coated from both sides with a layer or sheet of rubber composition 20. Optionally, such parallel cords 15 may be connected by a thin yarn or fiber, which may also be called weft. Where needed or desired, plies are cut into multiple parallel (overlay) strips. Such methods are well known to the person skilled in the art of tire building. After curing, the cords 15 are embedded in the rubber composition 20, reinforcing the same.

In general, cords 15 may be coated with dips and/or adhesives (or may be free of such materials) for better adhesion properties with regards to adhesion of the cords 15 to the rubber composition or matrix 20. Neither a dip nor an adhesive coating is shown in FIG. 2.

While the schematic drawing of FIG. 2 indicates four hybrid cords 15 according to the invention, the number of parallel cords per ply strip could be different, for instance between 2 and 10. A preferred ends per inch (epi) value could be between 10 and 40 epi, even more preferably between 15 and 30 epi, as for instance 20 or 24 epi. With a same or similar epi-value, the cord 15 could also be embedded in other plies such as but not limited to those shown in FIG. 1. The width w of the ply strip 12′ may be for instance in general between 3 and 20 mm (preferably 16 mm), preferably between 4 and 11 mm. The thickness t could be for instance in the range of from 0.7 mm to 1.7 mm. In general, the width w of the strip 12′ (essentially in parallel to the axial direction of the tire) is larger than the thickness t of the strip 12′ (essentially in the radial direction of the tire). The cords 15 extend in parallel to the length of the strip 12′ (perpendicular to the width w and thickness t directions).

FIG. 3 discloses a schematic cross section of a hybrid cord 15 comprising two aramid yarns (same hatching) and a polyamide yarn (different hatching). As apparent from the drawing, the cord 15 does not have a core or central yarn and no yarns wrapped around such a central core. In contrast, the three yarns are twisted about each other to form the cord 15 within the scope of the present invention. Each of the three yarns shown in FIG. 3 is twisted itself in accordance with the embodiments of the invention. However, the twist of each yarn cannot be shown in the cross section of FIG. 3.

The hybrid cords of this invention can be beneficially incorporated into tire overlay plies to enhance tire performance characteristics. Such an overlay ply is typically interposed between the radially outermost ply of the belt assembly and the tread and comprises one or more wraps having a width which is about equal to that of the widest of the belt plies. Alternatively, the overlay ply can consist of two separate axially spaced apart ply portions either disposed radially outwardly of the belt assembly such as to cover the edges of the radially outermost belt ply or interposed between the belt plies such as to extend between the edges thereof. Another possibility of assembling an overlay ply consists in interposing a helically wound cord or single yarn, which has been coated with elastomeric material, between the radially outermost ply of the belt assembly and the tread. As winding a single cord is time consuming, it has been proposed to assemble the overlay ply from a 5 to 30 mm wide, helically wound strip, made from cord reinforced elastomeric material, located radially outwardly to the belt plies.

Although the overlay structure can be comprised of only one layer, it can also be comprise a second layer located adjacent to and radially outside of the first layer. Preferably, the second layer should have its helical convolutions wound with the opposite hand to the first layer so that the cords of each layer cross at a very small angle. With such a construction the two layers can be wound continuously in succession without a break in the strip. It is to be understood that the helical convolutions of the helically wound strip, in place of being in abutment with any adjacent convolution, can also have an overlapping relationship with the previous convolutions, which overlap can be constant or variable across the width of the belt reinforcing structure without departing from the spirit of the instant invention. Such overlay structures and their incorporation into tires is described in U.S. Pat. No. 6,799,618 and the teachings of U.S. Pat. No. 6,799,618 are incorporated herein by reference for the purpose of describing such overlay structures.

Each of the yarns in a cord has its component filaments twisted together a given number of turns per unit of length of the yarn (usually expressed in turns per inch or “TPI”) and additionally the yarns are twisted together a given number of turns per unit of length of the cord. The direction of twist refers to the direction of slope of the spirals of a yarn or cord when it is held vertically. If the slope of the spirals conforms in direction to the slope of the letter “S”, then the twist is called “S” or “left hand”. If the slope of the spirals conforms in direction to the slope of the letter “Z”, then the twist is called “Z” or “right hand”. An “S” or “left hand” twist direction is understood to be an opposite direction from a “Z” or “right hand” twist. “Yarn twist” is understood to mean the twist imparted to a yarn before the yarn is incorporated into a cord, and “cord twist” is understood to mean the twist imparted to two or more yarns when they are twisted together with one another to form a cord. The term “dtex” is understood to mean the weight in grams of 10,000 meters of a yarn before the yarn has a twist imparted thereto.

For instance, the cord may have a construction of 1670/2 dtex aramid+940/1 dtex Nylon, twisted 8Z/7Z/7S twists per inch (tpi). In other words, 2 yarns or strands of aramid having each a weight of 1670 dtex are each twisted with 8 tpi in Z direction. A 940 dtex Nylon is twisted with 7 tpi also in Z direction. Finally, the three yarns are twisted with 7 tpi in the opposite S direction to form the cord out of the three yarns.

In any case, the cords can have a construction wherein two aramid yarns are twisted 5, 6, 7, or 8 tpi in the Z direction, wherein the polyamide yarn is twisted with 4, 5, 6, or 7 turns in the Z direction, and wherein the three yarns are twisted together 4, 5, 6, 7, 8, 9 or 10 turns in the S direction. The aramid yarns in these cords have a linear density which is within the range of 1400 dtex to 1900 dtex, which is frequently within the range of 1500 dtex to 1800 dtex, which is preferably within the range of 1600 dtex to 1700 dtex, and which is most preferably within the range of 1650 dtex to 1690 dtex. The aramid yarns in these cords have a linear density which is within the range of 750 dtex to 1200 dtex, which is frequently within the range of 800 dtex to 1100 dtex, which is preferably within the range of 900 dtex to 1000 dtex, and which is most preferably within the range of 920 dtex to 960 dtex.

Some specific cord constructions which are contemplated include the following: 1670/2 dtex aramid+940/1 dtex polyamide, twisted 5Z/4Z/7S tpi; 1670/2 dtex aramid+940/1 dtex polyamide, twisted 6Z/4Z/7S tpi; 1670/2 dtex aramid+940/1 dtex polyamide, twisted 7Z/4Z/7S tpi; 1670/2 dtex aramid+940/1 dtex polyamide, twisted 8Z/4Z/7S tpi; 1670/2 dtex aramid+940/1 dtex polyamide, twisted 5Z/5Z/7S tpi; 1670/2 dtex aramid+940/1 dtex polyamide, twisted 6Z/5Z/7S tpi; 1670/2 dtex aramid+940/1 dtex polyamide, twisted 7Z/5Z/7S tpi; 1670/2 dtex aramid+940/1 dtex polyamide, twisted 8Z/5Z/7S tpi; 1670/2 dtex aramid+940/1 dtex polyamide, twisted 5Z/6Z/7S tpi; 1670/2 dtex aramid+940/1 dtex polyamide, twisted 6Z/6Z/7S tpi; 1670/2 dtex aramid+940/1 dtex polyamide, twisted 7Z/6Z/7S tpi; 1670/2 dtex aramid+940/1 dtex polyamide, twisted 8Z/6Z/7S tpi; 1670/2 dtex aramid+940/1 dtex polyamide, twisted 5Z/7Z/7S tpi; 1670/2 dtex aramid+940/1 dtex polyamide, twisted 6Z/7Z/7S tpi; 1670/2 dtex aramid+940/1 dtex polyamide, twisted 7Z/7Z/7S tpi; 1670/2 dtex aramid+940/1 dtex polyamide, twisted 8Z/7Z/7S tpi; 1670/2 dtex aramid+940/1 dtex polyamide, twisted 5Z/4Z/6S tpi; 1670/2 dtex aramid+940/1 dtex polyamide, twisted 6Z/4Z/6S tpi; 1670/2 dtex aramid+940/1 dtex polyamide, twisted 7Z/4Z/6S tpi; 1670/2 dtex aramid+940/1 dtex polyamide, twisted 8Z/4Z/6S tpi; 1670/2 dtex aramid+940/1 dtex polyamide, twisted 5Z/5Z/6S tpi; 1670/2 dtex aramid+940/1 dtex polyamide, twisted 6Z/5Z/6S tpi; 1670/2 dtex aramid+940/1 dtex polyamide, twisted 7Z/5Z/6S tpi; 1670/2 dtex aramid+940/1 dtex polyamide, twisted 8Z/5Z/6S tpi; 1670/2 dtex aramid+940/1 dtex polyamide, twisted 5Z/6Z/6S tpi; 1670/2 dtex aramid+940/1 dtex polyamide, twisted 6Z/6Z/6S tpi; 1670/2 dtex aramid+940/1 dtex polyamide, twisted 7Z/6Z/6S tpi; 1670/2 dtex aramid+940/1 dtex polyamide, twisted 8Z/6Z/6S tpi; 1670/2 dtex aramid+940/1 dtex polyamide, twisted 5Z/7Z/6S tpi; 1670/2 dtex aramid+940/1 dtex polyamide, twisted 6Z/7Z/6S tpi; 1670/2 dtex aramid+940/1 dtex polyamide, twisted 7Z/7Z/6S tpi; 1670/2 dtex aramid+940/1 dtex polyamide, twisted 8Z/7Z/6S tpi; 1670/2 dtex aramid+940/1 dtex polyamide, twisted 5Z/4Z/5S tpi; 1670/2 dtex aramid+940/1 dtex polyamide, twisted 6Z/4Z/5S tpi; 1670/2 dtex aramid+940/1 dtex polyamide, twisted 7Z/4Z/5S tpi; 1670/2 dtex aramid+940/1 dtex polyamide, twisted 8Z/4Z/5S tpi; 1670/2 dtex aramid+940/1 dtex polyamide, twisted 5Z/5Z/5S tpi; 1670/2 dtex aramid+940/1 dtex polyamide, twisted 6Z/5Z/5S tpi; 1670/2 dtex aramid+940/1 dtex polyamide, twisted 7Z/5Z/5S tpi; 1670/2 dtex aramid+940/1 dtex polyamide, twisted 8Z/5Z/5S tpi; 1670/2 dtex aramid+940/1 dtex polyamide, twisted 5Z/6Z/5S tpi; 1670/2 dtex aramid+940/1 dtex polyamide, twisted 6Z/6Z/5S tpi; 1670/2 dtex aramid+940/1 dtex polyamide, twisted 7Z/6Z/5S tpi; 1670/2 dtex aramid+940/1 dtex polyamide, twisted 8Z/6Z/5S tpi; 1670/2 dtex aramid+940/1 dtex polyamide, twisted 5Z/7Z/5S tpi; 1670/2 dtex aramid+940/1 dtex polyamide, twisted 6Z/7Z/5S tpi; 1670/2 dtex aramid+940/1 dtex polyamide, twisted 7Z/7Z/5S tpi; 1670/2 dtex aramid+940/1 dtex polyamide, twisted 8Z/7Z/5S tpi; 1670/2 dtex aramid+940/1 dtex polyamide, twisted 5Z/4Z/4S tpi; 1670/2 dtex aramid+940/1 dtex polyamide, twisted 6Z/4Z/4S tpi; 1670/2 dtex aramid+940/1 dtex polyamide, twisted 7Z/4Z/4S tpi; 1670/2 dtex aramid+940/1 dtex polyamide, twisted 8Z/4Z/4S tpi; 1670/2 dtex aramid+940/1 dtex polyamide, twisted 5Z/5Z/4S tpi; 1670/2 dtex aramid+940/1 dtex polyamide, twisted 6Z/5Z/4S tpi; 1670/2 dtex aramid+940/1 dtex polyamide, twisted 7Z/5Z/4S tpi; 1670/2 dtex aramid+940/1 dtex polyamide, twisted 8Z/5Z/4S tpi; 1670/2 dtex aramid+940/1 dtex polyamide, twisted 5Z/6Z/4S tpi; 1670/2 dtex aramid+940/1 dtex polyamide, twisted 6Z/6Z/4S tpi; 1670/2 dtex aramid+940/1 dtex polyamide, twisted 7Z/6Z/4S tpi; 1670/2 dtex aramid+940/1 dtex polyamide, twisted 8Z/6Z/4S tpi; 1670/2 dtex aramid+940/1 dtex polyamide, twisted 5Z/7Z/4S tpi; 1670/2 dtex aramid+940/1 dtex polyamide, twisted 6Z/7Z/4S tpi; 1670/2 dtex aramid+940/1 dtex polyamide, twisted 7Z/7Z/4S tpi; 1670/2 dtex aramid+940/1 dtex polyamide, twisted 8Z/7Z/4S tpi; 1670/2 dtex aramid+940/1 dtex polyamide, twisted 5Z/4Z/8S tpi; 1670/2 dtex aramid+940/1 dtex polyamide, twisted 6Z/4Z/8S tpi; 1670/2 dtex aramid+940/1 dtex polyamide, twisted 7Z/4Z/8S tpi; 1670/2 dtex aramid+940/1 dtex polyamide, twisted 8Z/4Z/8S tpi; 1670/2 dtex aramid+940/1 dtex polyamide, twisted 5Z/5Z/8S tpi; 1670/2 dtex aramid+940/1 dtex polyamide, twisted 6Z/5Z/8S tpi; 1670/2 dtex aramid+940/1 dtex polyamide, twisted 7Z/5Z/8S tpi; 1670/2 dtex aramid+940/1 dtex polyamide, twisted 8Z/5Z/8S tpi; 1670/2 dtex aramid+940/1 dtex polyamide, twisted 5Z/6Z/8S tpi; 1670/2 dtex aramid+940/1 dtex polyamide, twisted 6Z/6Z/8S tpi; 1670/2 dtex aramid+940/1 dtex polyamide, twisted 7Z/6Z/8S tpi; 1670/2 dtex aramid+940/1 dtex polyamide, twisted 8Z/6Z/8S tpi; 1670/2 dtex aramid+940/1 dtex polyamide, twisted 5Z/7Z/8S tpi; 1670/2 dtex aramid+940/1 dtex polyamide, twisted 6Z/7Z/8S tpi; 1670/2 dtex aramid+940/1 dtex polyamide, twisted 7Z/7Z/8S tpi; 1670/2 dtex aramid+940/1 dtex polyamide, twisted 8Z/7Z/8S tpi; 1670/2 dtex aramid+940/1 dtex polyamide, twisted 5Z/4Z/9S tpi; 1670/2 dtex aramid+940/1 dtex polyamide, twisted 6Z/4Z/9S tpi; 1670/2 dtex aramid+940/1 dtex polyamide, twisted 7Z/4Z/9S tpi; 1670/2 dtex aramid+940/1 dtex polyamide, twisted 8Z/4Z/9S tpi; 1670/2 dtex aramid+940/1 dtex polyamide, twisted 5Z/5Z/9S tpi; 1670/2 dtex aramid+940/1 dtex polyamide, twisted 6Z/5Z/9S tpi; 1670/2 dtex aramid+940/1 dtex polyamide, twisted 7Z/5Z/9S tpi; 1670/2 dtex aramid+940/1 dtex polyamide, twisted 8Z/5Z/9S tpi; 1670/2 dtex aramid+940/1 dtex polyamide, twisted 5Z/6Z/9S tpi; 1670/2 dtex aramid+940/1 dtex polyamide, twisted 6Z/6Z/9S tpi; 1670/2 dtex aramid+940/1 dtex polyamide, twisted 7Z/6Z/9S tpi; 1670/2 dtex aramid+940/1 dtex polyamide, twisted 8Z/6Z/9S tpi; 1670/2 dtex aramid+940/1 dtex polyamide, twisted 5Z/7Z/9S tpi; 1670/2 dtex aramid+940/1 dtex polyamide, twisted 6Z/7Z/9S tpi; 1670/2 dtex aramid+940/1 dtex polyamide, twisted 7Z/7Z/9S tpi; 1670/2 dtex aramid+940/1 dtex polyamide, twisted 8Z/7Z/9S tpi; 1670/2 dtex aramid+940/1 dtex polyamide, twisted 5Z/4Z/10S tpi; 1670/2 dtex aramid+940/1 dtex polyamide, twisted 6Z/4Z/10S tpi; 1670/2 dtex aramid+940/1 dtex polyamide, twisted 7Z/4Z/10S tpi; 1670/2 dtex aramid+940/1 dtex polyamide, twisted 8Z/4Z/10S tpi; 1670/2 dtex aramid+940/1 dtex polyamide, twisted 5Z/5Z/10S tpi; 1670/2 dtex aramid+940/1 dtex polyamide, twisted 6Z/5Z/10S tpi; 1670/2 dtex aramid+940/1 dtex polyamide, twisted 7Z/5Z/10S tpi; 1670/2 dtex aramid+940/1 dtex polyamide, twisted 8Z/5Z/10S tpi; 1670/2 dtex aramid+940/1 dtex polyamide, twisted 5Z/6Z/10S tpi; 1670/2 dtex aramid+940/1 dtex polyamide, twisted 6Z/6Z/10S tpi; 1670/2 dtex aramid+940/1 dtex polyamide, twisted 7Z/6Z/10S tpi; 1670/2 dtex aramid+940/1 dtex polyamide, twisted 8Z/6Z/10S tpi; 1670/2 dtex aramid+940/1 dtex polyamide, twisted 5Z/7Z/10S tpi; 1670/2 dtex aramid+940/1 dtex polyamide, twisted 6Z/7Z/10S tpi; 1670/2 dtex aramid+940/1 dtex polyamide, twisted 7Z/7Z/10S tpi; and 1670/2 dtex aramid+940/1 dtex polyamide, twisted 8Z/7Z/10S tpi.

Variations in the present invention are possible in light of the provided description. While certain representative embodiments, examples and details have been shown for the purpose of illustrating the subject invention, it will be apparent to those skilled in this art that various changes and modifications can be made therein without departing from the scope of the invention. It is, therefore, to be understood that changes may be made in the particular example embodiments described which will be within scope of the invention as defined by the following appended claims.

In any case the above described embodiments and examples shall not be understood in a limiting sense. In particular, the features of the above embodiments may also be replaced or combined with one another.

1. A hybrid cord for a tire ply or ply strip, the cord comprising:
two aramid yarns, each aramid yarn having a density from 1400 dtex to 1900 dtex and being twisted in a first direction with 5 to 8 twists per inch,
a polyamide yarn having a density of 750 dtex to 1200 dtex and being twisted in the first direction with 4 to 7 twists per inch,
wherein the three yarns are twisted together with 4 to 10 twists per inch in a direction opposite to the first direction to form the cord.

2. The hybrid cord of claim 1, wherein the cord comprises exactly three yarns.

3. The hybrid cord of claim 1, wherein each aramid yarn has a density of 1500 to 1800 dtex.

4. The hybrid cord of claim 1, wherein each aramid yarn has a density of 1600 to 1700 dtex.

5. The hybrid cord of claim 1, wherein the polyamide yarn has a density of 800 to 1100 dtex.

6. The hybrid cord of claim 1, wherein the polyamide yarn has a density of 900 to 1000 dtex.

7. The hybrid cord of claim 1, wherein the number of twists per inch of each aramid yarn is larger than the number of twists per inch of the polyamide yarn.

8. The hybrid cord of claim 1, wherein the number of twists per inch of each aramid yarn is larger than the number of twists per inch of the polyamide yarn and wherein the number of twists per inch of the polyamide yarn and of the cord is the same.

9. The hybrid cord of claim 1, wherein the number of twists per inch of each aramid yarn has at least 10% twists per inch more than the polyamide yarn.

10. The hybrid cord of claim 1, wherein the number of twists per inch of each aramid yarn has between 10% to 25% twists per inch more than the polyamide yarn.

11. The hybrid cord of claim 1, wherein the number of twists per inch of the polyamide yarn and the number of twists per inch of the cord does not differ from each other in more than 0.5 twists per inch.

12. The hybrid cord of claim 1, wherein each aramid yarn is twisted with 7 to 9 twists per inch.

13. The hybrid cord of claim 1, wherein the polyamide yarn is twisted with 6 to 8 twists per inch.

14. The hybrid cord of claim 1, wherein the cord is twisted with 6 to 8 twists per inch.

15. The hybrid cord of claim 1, wherein the polyamide is nylon 6.6.

16. The hybrid cord of claim 1, wherein the cord has a construction 1670/2 dtex aramid+940/1 dtex Nylon, twisted with 8Z/7Z/7S twists per inch.

17. A pneumatic tire comprising at least one reinforcing ply component selected from the group consisting of a belt ply, a carcass ply, an overlay ply and an overlay ply strip, wherein the reinforcing ply component includes a plurality of the hybrid cords as specified in claim 1.

18. The pneumatic tire of claim 17 comprising a carcass with at least one carcass ply, a tread disposed radially outward of a crown region of the carcass, a belt with a plurality of belt plies arranged between the carcass ply and the tread, wherein the plurality of belt plies is covered by an overlay structure comprising a helically wound overlay ply strip, reinforced by a plurality of the cords and extending over the belt plies at an angle of between 0 and 5 degrees with the equatorial plane of the tire.

19. The pneumatic tire of claim 17 which includes an overly ply strip, wherein said strip has one or more of: a width (w) in the range of 4 mm to 18 mm, a thickness (t) in the range of 0.7 mm to 1.7 mm and a fabric density of from 10 to 40 ends per inch.

20. The pneumatic tire of claim 17, wherein the pneumatic tire is one of: a radial passenger car tire.
